(19) United States
(12) Patent Application Publication
(10) Pub. No.: US 2007/0279206 A1
(43) Pub. Date: Dec. 6, 2007

(54) Wireless car seat locator and child safety occupancy alert system

(76) Inventor: Joy S. Singfield, Uniondale, NY (US)

Correspondence Address: JOY S. SINGFIELD, 294 LACLEDE AVENUE, UNIONDALE, NY, 11553, US

(21) Appl. No.: 11/444,835

(22) Filed: Jun. 1, 2006

(51) Int. Cl. B60Q 1/00; G08B 23/00; G08B 1/08

(52) U.S. Cl. 340/457; 340/573.1; 340/539.13

(57) ABSTRACT

The Wireless location child carseat occupancy alert system is a tracking and notification device that both tracks the whereabouts of a child and serve as a reminder alert system of child carseat occupancy through attaching this wireless device to a (attachable, and/or detachable) carseat, and/or stroller. This devices serves as a safety device, which assists parents in locating their child, should their child be taken while in their vehicle, or stroller. In addition, this device serves as a safety tool which reminds the parent that the child is in the car, by playing a voice activated alert, or alert preprogrammed by the system, through a timed system preference setting.

### DESCRIPTION OF THE INVENTION

The Wireless location child carseat occupancy alert system attaches to the bottom, side, and/or rear of a child carseat, carrying device and/or stroller, or any other means of transporting a child from one destination to the other. This invention serves the purpose of enabling the parent to inconspicuously attach the device to monitor the child's whereabouts in the event of emergency where the child would need to be tracked. In addition, the Wireless location child carseat occupancy alert system is a weight sensitive device that automatically detects and records the weight of the child, and alerts the driver (after a default setting, or pre-programmed setting by the user) that the child is still in the carseat, and needs to be removed. This prevents children from being taken, and not tracked, and prevents children from being left in the car after long rides, or routes that may make it easy to forget the child. For example, after programmed 30 minutes, the Wireless location child carseat occupancy alert system sends and alert that sounds aloud, so the driver can hear, and be reminded that the child is still in the car. The alerts are then recorded to the network, and sent to the user's email account, and/or emailed as an instant message on their mobile device, or wireless device.

### Product and System Features

i. Wireless (and option for non wireless), and automatic weight sensor—to detect weight when child is placed in carseat.
ii. Bluetooth enabled (intel inside)—to allow wireless communication to wireless network, sending wireless alerts
iii. Usb port, Firewire port, Ability to download log of alert report (log of alerts taken place on device)—as an alternative to using wireless feature.
iv. Wi-Fi, and Wi-Max compatible—wireless system network and communications, to deliver alerts and log reports to online user account, mobile phone, wireless device(s), as set by user in user's online account log on feature
v. Website for user to navigate and set system and operation settings for device
vi. Serial number, attached to device, in order to register; with system capability to make device inactive if serial number recorded for device theft, lost report—automatically makes device inactive, unable to be used.. and reported to manufacturer as “stolen” in active (similar to tracking workings on wireless phone SIM Cards).
vii. Built in weight sensor
viii. Built in (internal) timer (with default time button i.e. 30 minutes)—to beep at designated time frame/time period.
ix. Seatbelt sensor (identifies major activity on seatbelt, and recognizes
x. Infrared beam built in
xi. Beam reflector attachment, to be placed on side of carseat, to detect user seatbelt activity, to prompt beep in system.
xii. Velcro, to attach device to bottom, side, (anywhere user seems fit) to carseat.
xiii. On and off button.
xiv. Power button
xv. Alert settings button options (switch)—option for voice alert, beep alert, or tri-alert (including mobile device alert)—wireless alert can be set online—and sent to multiple parties (up to five users).
xvi. Speakers to allow user to hear beep, and voice options
xvii. Volume button, to adjust beep to user's/driver's discretion.
xviii. Email, mobile phone alert to remind user child is in car, every 30 minutes (default), can be programmed (on system—every 15 minutes, 45 minutes, 60 minutes)—as user/driver sees fit/necessary, to accommodate their travel.
xix. Movement sensor, that detects constant movement (can be used if carseat is not securely in, in addition to being attached to seatbelt outside top of belt,, to detect when seatbelt has been removed.
xx. Also option for sensor device to communicate with lock of seatbelt.. pre-programmed in device to be capable for dealership, to include sensor communications to communicate with carseat lock sensor, indicating seatbelt on/off—to prompt notification to driver.

### BACKGROUND OF THE INVENTION

Problem:

1) There are no wireless location tracking devices to track the whereabouts of children in their carseats that may be in vehicles, or in strollers of stolen or lost vehicles.
2) There is no immediate record of system workings that can be sent to notify user aloud, or via email, and/or text message of location, and/or alert status of child location tracking, and reminder available to drivers.
3) Over 40 children from infants to 3 years old children incidents of hyperthermia deaths per year due to children being left accidentally in their parents', or guardians' cars.
4) There were 35 cases Hyperthermia in 2004, 42 in 2003, 30 in 2002, that lead to the deaths of children in the U.S. alone.
   Our Solution:
1) Providing a device that locates the child carseat in vehicle, that is securely attached to carseat and/or stroller (via Velcro, or any other material, or chemical that will permit secure fastening of device.
2) Device has wireless (wi-fi, wi-max) capability to connect to a wireless network, and permit wireless transmission of data, to deliver notifications, alerts, and system request confirmations; permitting wireless communication of alerts, and/or alert and progress reports—Also has usb, FW ports to backup log directly from device.
3) Device that reminds user/driver that child is in the vehicle
   1) when seatbelt is taken off (seatbelt sensor of movement detected)
   2) when timer has de
   3)
4) Worldwide advertising and availability to all of product—device will be made available both in the United States and internationally, through online, and manufacturer, vendor distribution and packaging.
   Consumer Need:
1) “On the go” moms and dads leaving for work with their children in the car, and must drop them off in between hectic work schedules.
2) Parents and/or guardians taking long and/or extensive trips can easily forget a child is in the car.
3) Anyone traveling with a child that needs to be reminded occasionally (especially in severe climate conditions) that a child is with them in travel (in the vehicle).
4) Parents and/or guardians, family members that do not usually transport the child to daycare, or regular schedule routine—that aren't used to formulating child in their schedule.

### BRIEF DESCRIPTION THE INVENTION

According to the 4Kids Safe Organization's national database for tracking statistics of children left unattended in or around cars, over 30 children fall prey to Hyperthermia, due to being left in the car unattended.

As per, the LA Times, 42 children died as a result last year, and over 200 since 1996, while frazzled parents fall under the influence of hectic work schedules, and forget their child in the car. This product prevents this tragic occurrence, by providing a multitude of successful alerts to driver throughout the course of the drive, and whenever seatbelt is detached.

### DESCRIPTION OF DRAWINGS

Descriptions of the enclosed drawings are as follows:

FIG. 1 FRONT:B is extendable antenna; Bb is keypad lock button, password protection front C is timer screen, to set time system should voice, and/or mobile alert; Cc is timer buttons to set preferences; D is power status light button; E is panic button G is infrared beam; Ca is attacher and extendable unit; A is voice recorder button, to set voice record, to playback name of child, as reminder FIG. 1 (BACK): H is Velcro; J is alert settings; I is on/off button; L is firewire port, to back up data K is usb port to back up data of program reports and settings; Hh is built in weight sensor; B is extendable antenna

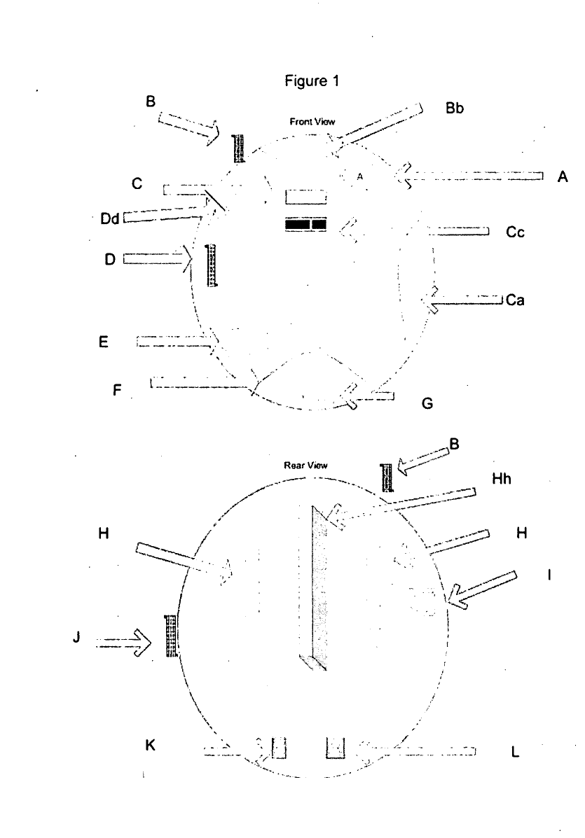

FIG. 2: H is device signal; I is wireless network J is linked to users account, through device, serial number and online Registration; Jj is recorded voice that plays pre-recorded or system recorded voice prompts and alerts, pre-preferenced by user via device or online account, accessible via internet-playbacks and system functionings are all recorded on system network

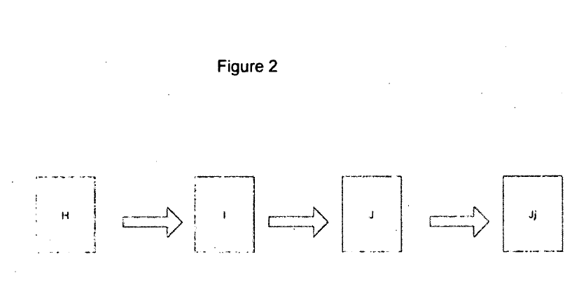

FIG. 3: A is device B is seatbelt sensor; C is wireless network; D is computer usb firewire, and Computer and usb, firewire drivers; E is weight sensor; F is voice recorder G is seatbelt alert tone recognizer/detector; Bb is detect driver that identifies whether seatbelt is locked and secure; Cc is system to view trackings; Dd is data backup mechanism, hard drive; Dd2 is device upgrade capabilities system; Ee is detect child occupying carseat tracking; Gg is automatic voice prompting system in device to automatically alert driver child is still in seat; Gg2 is “child in car”“child in car alert voice activated system-Voice alert; Gg3 is pre-recorded voice alert command, i.e. “Johnny in carseat”

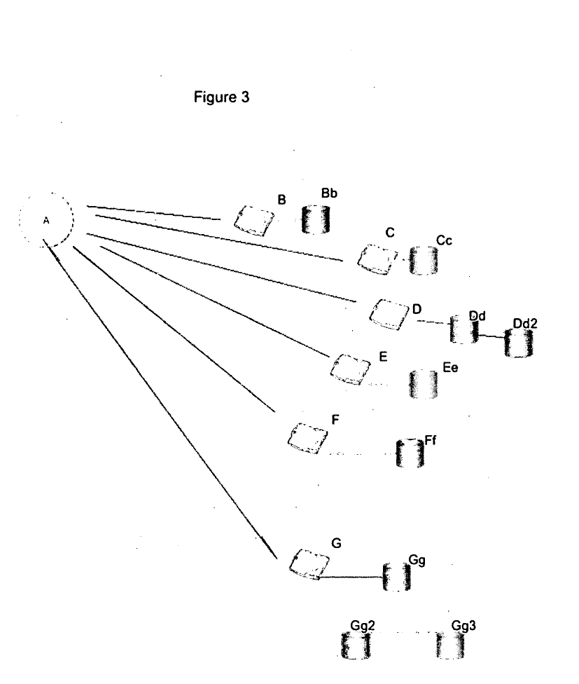

FIG. 4: Bc is wireless network communicating with A, the device; A is tracking device D is delivery to operating system or cell phone; C is system operations—To view, alert history, voice record, record user preferences management system, child history, and location history of transactions

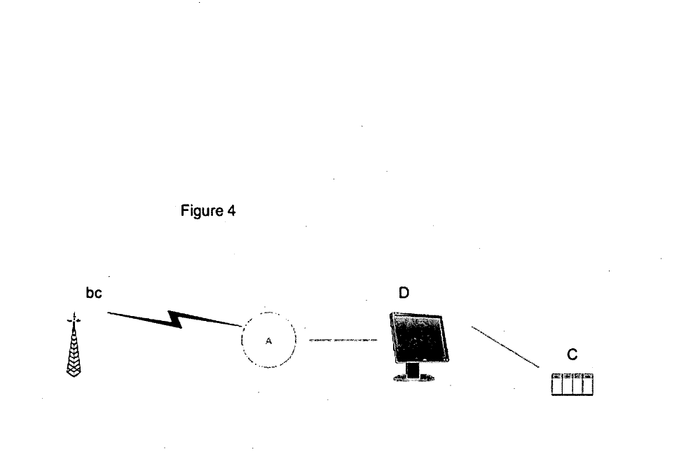

FIG. 5: A is the tracking device in the form of a wireless chip, attachable to any unit; Aa is the sensor connection and signal; Ab is the voice recognition connector signalAal is the seatbelt and weight sensor; Aab2 is the seatbelt alert system (seatbelt on, measures security of child weight to seat.

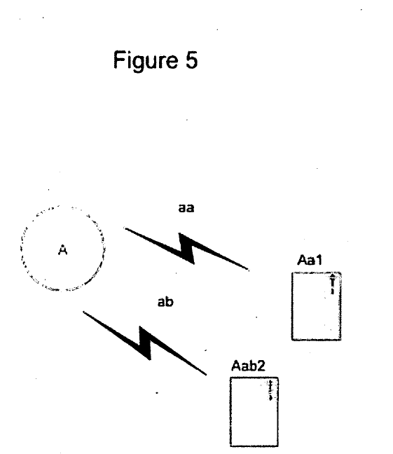

What I claim to be invented by myself and new are the following:

1) A wireless device that is attached to child carseat, and/or stroller (including any carrying tool used to transport children) and tracks the travel of children; is preprogrammed to alert the user after child is in the carseat for a specified amount of time (i.e. 30 minutes, 15 minutes, 45 minutes, 60 minutes.. reminding driver every 15 minutes, and/or reminding every 30 minutes), and enables users (parents) to track child location and monitor weight.

2) A wireless device that has an automatic weight sensor, to detect when child is in carseat, to begin timer, enables users the ability to set alert preferences online, connected to a wireless network to provide user with wireless, online system options, and system monitoring capabilities, an inclusive chip, that recognizes child location, able to receive (infared) device signals that intertwine with driver's seat belt, to recognize that driver has removed his seat belt, and should remove child from vehicle

3) Voice activated response system, notifies by voice, by beep, by alert (mobile text alert, and/or wireless alert)—one, two, or all three options—to remind user to remove child from carseat, Motion detector that detects motion of the driver's seat belt, to alert driver to remove child from carseat; Weight sensor that detects when child has been put in seat, to begin device timing to prepare driver automatic notification, Device beep option—where device beeps when child is input into carseat (to verify to user that child presence has been identified, through child weight (weight recorder option preinstalled in device to monitor, and check, and record weight of child—sent to user's online account, where user/driver can view child notification activity, along with recorded time, date, and weight of child, length of ride, length of notification, tracking of where vehicle traveled with child) )—also voice recognition option—where device states aloud that child has been detected i.e. “child identified”, “good morning”, “good afternoon”—depending on user time zone setting on user's online account—linked to child device.

4) Device beep option—where device beeps when driver's seatbelt has been removed, to automatically remind, and alert driver to remove child from carseat before exiting the vehicle (device notification rings to alert, beeps to alert, and/or speaks to alert—user can choose one or all options as an alert); preinstalled micro-chip that alerts driver as well.. built in car)).. accompanies seatbelt sensor, upgradeable on all car systems.. can be built in before dealership sale, or installed by any consumer, and/or dealership; Contains a sensor that communicates with the same seatbelt sensor that sends a signal to the driver's dashboard, to alert them seatbelt is not on—to remind the driver that child is still in the car.

5) Preinstalled Sound recognition that records and recalls the sound of the seatbelt alert tone (alerting driver seatbelt unlocked), and uses the sound as a recognition signal to prompt the wireless device to alert the user through voice operated system (pre-installed) device capabilities—to alert the user that child is in the car—to remove the child from the carseat.

6) Unit attachable to child carseat, and/or stroller, and/or any device used as a tool to transport child from one location to another, Device capability to program to alert using different, pre-programmed commands, or commands the user sets through Pre-Installed voice recorder; Voice recorder that can record the voice of the child during travel, which can be downloaded—voice recorder also to capture and store sound of new commands user/driver/ or owner of the device wishes to send; Pre-installed camera option capability,

7) Password protected option, to keep unwanted users from resetting, or making unnecessary changes to device.

8) Wireless weight sensor—to detect weight when child is placed in carseat.

9) Bluetooth enabled (intel inside)—to allow wireless communication to wireless network, sending wireless alerts, Usb port, Firewire port, Ability to download log of alert report (log of alerts taken place on device)—as an alternative to using wireless feature, Wi-Fi, and Wi-Max compatible—wireless system network and communications, to deliver alerts and log reports to online user account, mobile phone, wireless device(s), as set by user in user's online account log on feature.

10) Website for user to navigate and set system and operation settings for device, Serial number, attached to device, in order to register; with system capability to make device inactive if serial number recorded for device theft, lost report—automatically makes device inactive, unable to be used.. and reported to manufacturer as “stolen” in active (similar to tracking workings on wireless phone SIM Cards), Built in weight sensor, Built in (internal) timer (with default time button i.e. 30 minutes)—to beep at designated time frame/time period, Seatbelt sensor (identifies major activity on seatbelt, and recognizes, Infrared beam built in Beam reflector attachment, to be placed on side of carseat, to detect user seatbelt activity, to prompt beep in system electro, to attach device to bottom, side, (anywhere user seems fit) to carseat, On and off button/ Power button, alert settings button options (switch)—option for voice alert, beep alert, or tri-alert (including mobile device alert)—wireless alert can be set online—and sent to multiple parties (up to five users).

11) Speakers to allow user to hear beep, and voice options, Volume button, to adjust beep to user's/driver's discretion; email, mobile phone alert to remind user child is in car, every 30 minutes (default), can be programmed (on system—every 15 minutes, 45 minutes, 60 minutes) —as user/driver sees fit/necessary, to accommodate their travel, Movement sensor, that detects constant movement (can be used if carseat is not securely in, in addition to being attached to seatbelt outside top of belt,, to detect when seatbelt has been removed, Also option for sensor device to communicate with lock of seatbelt.. pre-programmed in device to be capable for dealership, to include sensor communications to communicate with carseat lock sensor, indicating seatbelt on/off—to prompt notification to driver, Keypad lock on device, to prevent changes possibly made in error.
